(19) United States
(12) Patent Application Publication
(10) Pub. No.: US 2016/0189243 A1
(43) Pub. Date: Jun. 30, 2016

(54) USER-QUALIFIED ADVERTISEMENT OFFER

(71) Applicant: Yahoo! Inc., Sunnyvale, CA (US)

(72) Inventors: Robert Douglas Sharp, San Francisco, CA (US); Varun Bhagwan, San Jose, CA (US)

(21) Appl. No.: 14/588,366

(22) Filed: Dec. 31, 2014

(51) Int. Cl. G06Q 30/02

(52) U.S. Cl. CPC G06Q 30/0275; G06Q 30/0257

(57) ABSTRACT

Briefly, embodiments disclosed herein relate to obtaining bids on user-qualified advertisement offers.

### BACKGROUND

1. Field

Subject matter disclosed herein may relate to obtaining bids on user-qualified advertisement offers.

2. Information

With networks, such as the Internet, gaining popularity, and with a vast multitude of content, such as pages, other electronic documents, other media content and/or applications (hereinafter ‘digital content’), becoming available to users, such as via the World Wide Web (hereinafter ‘Web’), it may be desirable to provide more efficient and/or more streamlined approaches to gather, organize and/or display content, such as digital content, that may be desired by and/or useful to a user, for example. Internet-type business entities, such as Yahoo!, for example, may provide a wide range of content, such as digital content, that may be made available to users, such as via the Web. Internet-type business entities, such as Yahoo!, for example, may provide web content publishing services and/or may display advertisements in connection with published Web content, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an example Web page including an advertisement display area in accordance with an embodiment.

FIG. 2 is a schematic diagram illustrating an example display advertisement system in accordance with an embodiment.

FIG. 3 is a flow diagram illustrating an example process for obtaining bids to fulfill a selected advertisement offer, in accordance with an embodiment.

FIG. 4 is a schematic diagram illustrating an example advertisement exchange system, in accordance with an embodiment.

FIG. 5 is a schematic diagram illustrating an example content publisher computing system, in accordance with an embodiment.

FIG. 6 is a schematic diagram illustrating an example computing device in accordance with an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be compliant and/or compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes so as to be capable to transmit signal packets and/or frames between devices of particular nodes including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but such devices outside the private network may not necessarily be able to direct inbound network communications to devices included in the private network.

The Internet refers to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately compatible and/or compliant signal packets and/or frames. It is noted that there are several versions of the Hypertext Transfer Protocol. Here, the term Hypertext Transfer Protocol, HTTP, and/or similar terms is intended to refer to any version, now known and/or later developed. It is likewise noted that in various places in this document substitution of the term Internet with the term World Wide Web (‘Web’) may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility that may be accessible to tens of millions of people or more worldwide. Also, in an embodiment, and as mentioned above, the terms “WWW” and/or “Web” refer to a part of the Internet that complies with the Hypertext Transfer Protocol. The Internet and/or the Web, therefore, in this context, may comprise an service that organizes stored content, such as, for example, text, images, video, etc., through the use of hypermedia, for example. A HyperText Markup Language (“HTML”), for example, may be utilized to specify content and/or to specify a format for hypermedia type content, such as in the form of a file and/or an “electronic document,” such as a Web page, for example. An Extensible Markup Language (“XML”) may also be utilized to specify content and/or format of hypermedia type content, such as in the form of a file or an “electronic document,” such as a Web page, in an embodiment. Of course, HTML and/or XML are merely example languages provided as illustrations.

Furthermore, HTML and/or XML (and/or similar terms) is intended to refer to any version, now known and/or later developed of these languages. Likewise, claimed subject matter is not intended to be limited to examples provided as illustrations, of course.

As used herein, the term “Web site” and/or similar terms refer to a collection of related Web pages. Also as used herein, “Web page” and/or similar terms refer to any electronic file and/or electronic document, such as may be accessible via a network, including by specifying a URL for accessibility via the Web, in an example embodiment. As alluded to above, in one or more embodiments, a Web page may comprise content coded using one or more languages, such as, for example, markup languages, including HTML and/or XML, although claimed subject matter is not limited in scope in this respect. Also, in one or more embodiments, application developers may write code in the form of JavaScript, for example, to provide content to populate one or more templates, such as for an application. The term ‘JavaScript’ and/or similar terms are intended to refer to any now known and/or later developed version of this programming language. However, JavaScript is merely an example programming language. As was mentioned, claimed subject matter is not intended to be limited to examples and/or illustrations.

As used herein, the terms “entry”, “electronic entry”, “document”, “electronic document”, “content”, “digital content”, “item”, and/or similar terms are meant to refer to signals and/or states in a physical format, such as a digital signal and/or digital state format, e.g., that may be perceived by a user if displayed, played and/or otherwise executed by a device, such as a digital device, including, for example, a computing device, but otherwise might not necessarily be perceivable by humans (e.g., in a digital format). Likewise, in this context, content (e.g., digital content) provided to a user in a form so that the user is able to perceive the underlying content itself (e.g., hear audio or see images, as examples) is referred to, with respect to the user, as ‘consuming’ content, ‘consumption’ of content, ‘consumable’ content and/or similar terms. For one or more embodiments, an electronic document may comprise a Web page coded in a markup language, such as, for example, HTML (hypertext markup language). In another embodiment, an electronic document may comprise a portion or a region of a Web page. Additionally, content may comprise email. However, claimed subject matter is not intended to be limited in these respects. Also, for one or more embodiments, an electronic document and/or electronic entry may comprise a number of components. Components in one or more embodiments may comprise text, for example, in the form of physical signals and/or physical states (e.g., capable of being physically displayed). Also, for one or more embodiments, components may comprise a graphical object, such as, for example, an image, such as a digital image, and/or sub-objects, such as attributes thereof, which, again, comprise physical signals and/or physical states (e.g., capable of being physically displayed). In an embodiment, content may comprise, for example, text, images, audio, video, and/or other types of electronic documents and/or portions thereof, for example.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as time of day at which an image was captured, latitude and longitude of an image capture device, such as a camera, for example, etc. In another example, one or more parameters relevant to content, such as content comprising a technical article, may include one or more authors, for example. Claimed subject matter is intended to embrace meaningful, descriptive parameters in any format, so long as the one or more parameters comprise physical signals and/or states, which may include, as parameter examples, name of the collection of signals and/or states (e.g., file identifier name), technique of creation of an electronic document, purpose of an electronic document, time and date of creation of an electronic document, logical path of an electronic document (or portion thereof), encoding formats and/or standards used for encoding an electronic document, and so forth.

Signal packets and/or frames, also referred to as signal packet transmissions and/or signal frame transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path, such as comprising a portion of the Internet and/or the Web, from a site via an access node coupled to the Internet. Likewise, a signal packet and/or frame may be forwarded via network nodes to a target site coupled to a local network, for example. A signal packet and/or frame communicated via the Internet and/or the Web, for example, may be routed via a path comprising one or more gateways, servers, etc. that may, for example, route a signal packet and/or frame in accordance with a target and/or destination address and availability of a network path of network nodes to the target and/or destination address. Although the Internet and/or the Web comprises a network of interoperable networks, not all of those interoperable networks are necessarily available and/or accessible to the public.

In particular implementations, a network protocol for communicating between devices may be characterized, at least in part, substantially in accordance with a layered description, such as the so-called Open Systems Interconnection (OSI) seven layer approach and/or description. A network protocol refers to a set of signaling conventions, such as for computing and/or communications transmissions, as may, for example, take place between and/or among devices in a network, typically network devices; for example, devices that substantially comply with the protocol and/or that are substantially compatible with the protocol. In this context, the term “between” and/or similar terms are understood to include “among” if appropriate for the particular usage and vice-versa. Likewise, in this context, the terms “compatible with”, “comply with” and/or similar terms are understood to include substantial compliance and/or substantial compatibility.

Typically, a network protocol, such as protocols characterized substantially in accordance with the aforementioned OSI description, has several layers. These layers may be referred to here as a network stack. Various types of transmissions, such as network transmissions, may occur across various layers. A lowest level layer in a network stack, such as the so-called physical layer, may characterize how symbols (e.g., bits and/or bytes) are transmitted as one or more signals (and/or signal samples) over a physical medium (e.g., twisted pair copper wire, coaxial cable, fiber optic cable, wireless air interface, combinations thereof, etc.). Progressing to higher-level layers in a network protocol stack, additional operations may be available by initiating network transmissions that are compatible and/or compliant with a particular network protocol at these higher-level layers. For example, higher-level layers of a network protocol may, for example, affect device permissions, user permissions, etc.

A virtual private network (VPN) may enable a remote device to more securely (e.g., more privately) communicate via a local network. A router may allow network communications in the form of network transmissions (e.g., signal packets and/or frames), for example, to occur from a remote device to a VPN server on a local network. A remote device may be authenticated and a VPN server, for example, may create a special route between a local network and the remote device through an intervening router. However, a route may be generated and/or also regenerated if the remote device is power cycled, for example. Also, a VPN typically may affect a single remote device, for example, in some situations.

A network may be very large, such as comprising thousands of nodes, millions of nodes, billions of nodes, or more, as examples. As mentioned, with networks, such as the Internet and/or the Web, gaining popularity, and with a vast multitude of content, such as pages, other electronic documents, other media content and/or applications (hereinafter ‘digital content’), becoming available to users, such as via the World Wide Web (herein ‘Web’), it may be desirable to provide more efficient and/or more streamlined approaches to gather, organize and/or display content, such as digital content, that may be desired by and/or useful to a user, for example. Internet-type business entities, such as Yahoo!, for example, may provide a wide range of content, such as digital content, that may be made available to users, such as via the Web. Internet-type business entities, such as Yahoo!, for example, may provide web content publishing services and/or may display advertisements in connection with published Web content, for example. Internet-type business entities may also provide email services, for example.

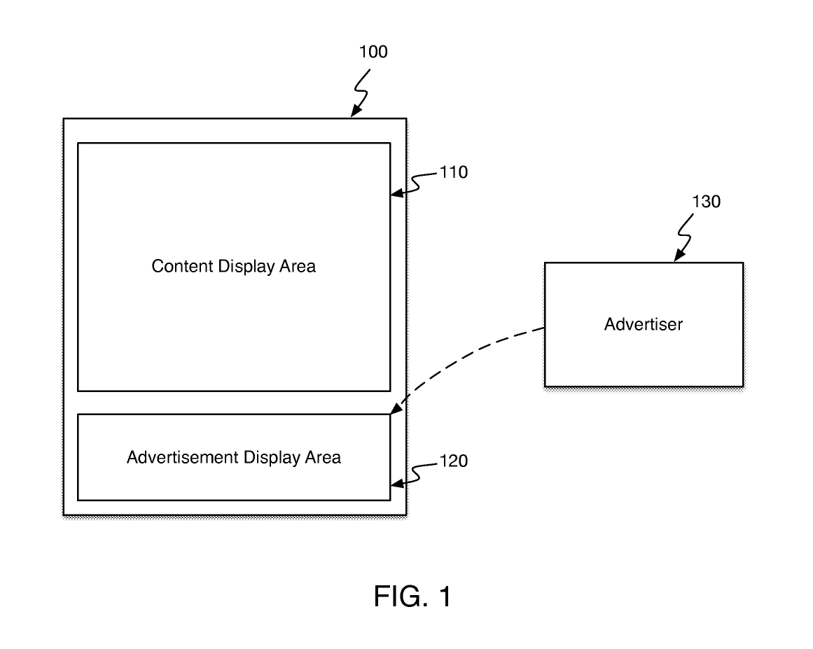

FIG. 1 is a schematic diagram illustrating an embodiment 100 of an example Web page including a content display area 110 and/or an advertisement display area 120. In an embodiment, a content publisher, such as a Web page publisher, may provide content, such as Web page 100, to one or more user computing devices. For example, a user may browse to a Web page, such as Web page 100, utilizing a browsing application executed on a user computing device, and a Web page publisher computing device may transmit content, such as Web page 100, to the user computing device to be displayed to the user. Also, in an embodiment, content displayed in content display area 110 may comprise email, for example. Further, in an embodiment, one or more advertisements may be displayed. For example, one or more advertisements may be displayed in advertisement display area 120, in an embodiment.

To encourage more frequent and/or greater overall amounts of user visits to, and/or other user engagements with, content, such as Web page 100, for example, it may be advantageous to personalize content presented to a user. In an embodiment, content to be presented to a user may be selected based, at least in part, on types of subject matter determined to be of likely interest to a user. For example, one or more electronic documents and/or advertisements to be presented to a user in one or more regions of a Web page may be selected based at least in part on a user's previous browsing behavior and/or email content, which may be tracked and/or analyzed, in an embodiment. Also, for example, a user's purchasing behavior may be tracked and/or analyzed to determine, at least in part, one or more electronic documents and/or advertisements to be presented to a user.

A content publishing entity, such as a Web content publishing entity, may sell advertisement space, such as one or more regions of a Web page, to one or more advertisers, in an embodiment. For example, a content publishing entity may provide one or more regions in a Web page, such as advertisement display area 120 of Web page 100, in which an advertiser, such as advertiser 130, may display an advertisement. In an embodiment, a number of advertisers may bid for an opportunity to display an advertisement in a Web page. For example, at least in part in response to a user browsing to a Web page, such as Web page 100, a content publisher may obtain one or more bids from one or more advertisers for an opportunity to display an ad in a region of a Web page, such as advertisement display area 120. An advertiser may select an advertisement to display to a user based at least in part on on one or more attributes of a user, in an embodiment. For example, if a browsing history for a particular user indicates that the user often visits Web sites related to travel, an advertisement related to travel may be selected for display to a user. An advertiser may attempt to match an advertisement with a user in a manner that might entice a user to select, or “click”, an advertisement. Significant effort may be made to track user browsing activity and/or to determine one or more user attributes to enable advertisers to better match advertisements with individual users.

However, at least in part due to an advertisement bidding process whereby advertisers bid on opportunities to display advertisements to individual users in response to a user browsing to a Web page, for example, challenges may be faced in targeting individual users with specific advertisements. For example, a user may express, for example through browsing activity, a desire to travel to a specified city over a range of a specified range of dates. A user may have a history of traveling to a specified city and/or staying at a particular hotel, for example. A user's email content may indicate plans to travel to a specified city and/or to stay at a specified hotel, for example. However, because advertisements may generally not be targeted in a sufficiently narrow manner, travel history and/or plans for an individual user may not be useful to an advertiser because it may be unlikely that an advertiser would have an advertisement ready for display that would cover the particular habits and/or intentions of the particular user. For example, it is unlikely that an advertiser would have an advertisement prepared that would cover travel to a particular city, staying at a particular hotel, over a particular range of dates.

Additionally, for advertisement systems that rely on advertisers to provide advertisements for display in connection with content, such as a Web page, it may prove a challenge for a content publisher to exert much, if any, control over the quality of advertisement content and/or presentation. For example, an advertiser may provide an advertisement that flashes, bounces, and/or plays audio in a manner that is designed to catch a user's attention. In some circumstances, such advertisements may have a negative impact on user browsing experience, which may result, at least in part, on a reduction in user views and/or other user engagements with published content.

In an embodiment, rather than displaying an advertisement provided by an advertiser to a user, a content publisher, such as a Web page publisher, may prepare one or more advertisements for display to a user. For example, a user may browse to a Web page, and an advertisement prepared by a Web page publisher may be displayed in a region of the Web page. In an embodiment, an advertisement may be generated and/or selected based at least in part on user browsing history, email content, and/or one or more user attributes. Also, in an embodiment, an advertisement may comprise an offer for specified goods and/or services. For example, a user traveling to a specified city on a specified date, as determined by user browsing activity, email content, and/or by express user input, and having a history of staying at a particular hotel, may be presented an advertisement with an offer of one or more nights stay at the particular hotel. At least in part in response to a selection of an advertisement offer, such as by the user clicking on the advertisement offer, a content publisher may obtain one or more bids from one or more providers to fulfill the advertisement offer, in an embodiment. For example, at least in part in response to a user clicking on an advertisement offer of a stay at a specified hotel in a city on a specified date, one or more bids may be obtained from a provider, such as from a hotel chain for the specified hotel, to fulfill the offer selected by the user. For this particular example, in response to a content publisher accepting a bid from a provider capable of booking a stay at the specified hotel for the specified date, a user may be directed to a Web site that may facilitate booking of the hotel stay. Alternatively, for another example, an advertisement from a provider may be displayed to a user in response to a content publisher accepting a bid from the provider. Of course, claimed subject matter is not limited to the specific examples described herein.

In an embodiment, by soliciting bids for advertisement offers that have already been selected by a user, a content publisher may more advantageously leverage user browsing history, email content, and/or one or more user attributes to more narrowly target advertisements, and/or may generate increased advertisement revenue. For example, advertisers and/or providers may be more willing to pay increased prices for an opportunity to display an advertisement to an individual user and/or for an opportunity to provide a good and/or service to an individual user if the individual user has already indicated interest in a specified good and/or service. Additionally, at least in part because content providers may display advertisements prior to bidding out to providers, content providers may have increased control over the quality and/or presentation of advertisement content, thereby potentially improving user viewing and/or browsing experience.

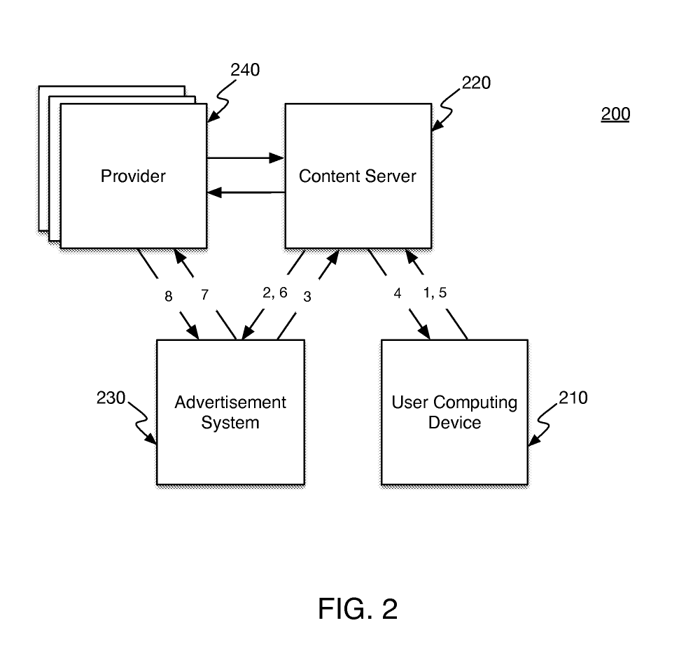

FIG. 2 is a schematic diagram illustrating an embodiment 200 of an example display advertisement system. In an embodiment, a user may access content hosted by a content server, such as content server 220. For example, a browsing application may be executed on a computing device, such as user computing device 210. A user may browse to content, such as a Web page, hosted by a server computing device, such as content server 220, as indicated in FIG. 2 by an arrow labeled “1”. In an embodiment, content, such as a Web page, may include one or more regions wherein an advertisement may be displayed. In an embodiment, a content server, such as content server 220, may indicate to an advertisement system, such as advertisement system 230, that a specified user has browsed to a specified Web site, for example, as indicated by arrow “2” depicted in FIG. 2. Advertisement system 230 may select and/or generate an advertisement offer to display to a specified user based, at least in part, on one or more user attributes, email content, and/or on user browsing history, in an embodiment. In an embodiment, a targeted advertisement offer for a specified user may be transmitted to content server 220 from advertisement system 230, for example, as indicated by arrow “3”.

In an embodiment, a content server, such as content server 220, and an advertisement system, such as advertisement system 230, may comprise the same business entity and/or may comprise the same computing device. For example, in an embodiment, content server 220 and advertisement system 230 may be implemented on a single server computing device, and/or within an individual network owned and/or operated by an individual business entity. In another embodiment, an advertisement system, such as advertisement system 230, may comprise a different business entity from that of a content server, such as content server 220.

Returning to the example depicted in FIG. 2, an advertisement offer provided by an advertisement system, such as advertisement system 230, may be displayed to a user, as indicated by arrow “4”. In an embodiment, an advertisement offer may be displayed in one or more regions of a Web page, for example, such as a Web page navigated to by a user. In an embodiment, a user may select an advertisement offer, such as by clicking on the offer, for example, as indicated by arrow “5” of FIG. 2. At least in part in response to a selection of an advertisement offer, a content server, such as content server 220, may communicate the selection to an advertisement system, such as advertisement system 230, in an embodiment, as indicated by arrow “6”.

Additionally, in an embodiment, at least in part in response to receiving an indication of a selection of an advertisement offer, an advertisement system, such as advertisement system 230, may solicit bids from one or more providers, such as providers 240. For the example depicted in FIG. 2, solicitation of bids by advertisement system 230 from providers 240 is represented by arrow “7”, and bids obtained from providers 240 are represented by arrow “8”. Also, in an embodiment, at least in part in response to acceptance of a bid, one or more of providers 240 may communicate with user computing device 210 by way of content server 220, for example. In this manner, a provider of goods and/or services, such as one or more of providers 240, may fulfill an advertisement offer selected by a user. For example, if the advertisement offer comprises an offer to purchase tickets to a basketball game involving a specified basketball team, a ticket broker and/or team box office may bid on a selected offer, and a user may be directed to a Web site operated by the ticket broker and/or box office, in an embodiment. In another embodiment, for this particular example, a ticket broker and/or team box office may display an additional advertisement to the user at least in part in response to acceptance of a bid. Of course, claimed subject matter is not limited in scope to the particular examples described herein.

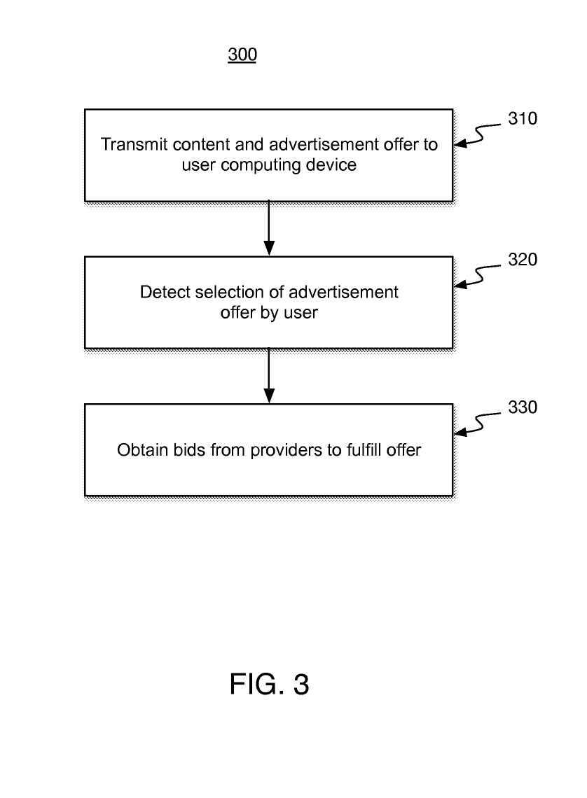

FIG. 3 is a flow diagram illustrating an embodiment 300 of an example process for obtaining bids to fulfill a selected advertisement offer. As indicated at block 310, content and/or an advertisement offer may be transmitted to a user computing device, in an embodiment. For example, a user may browse to a Web page, and the Web page and an advertisement offer to be displayed in the Web page may be transmitted to a user computing device. For another example, a user may access email, and email content and an advertisement offer to be displayed along with the email content may be transmitted to a user computing device. Further, in an embodiment, a selection of an advertisement offer by a user may be detected, as indicated at block 320. As further indicated at block 330, one or more bids to fulfill a selected advertisement offer may be obtained from one or more providers of goods and/or services, in an embodiment.

As used herein, the term “fulfill” as it relates to an advertisement offer refers to a provider of goods and/or services responding to an acceptance of an advertisement offer by a user at least in part through additional communication with the user to enable the user to purchase and/or otherwise obtain goods and/or services described in the advertisement offer. Also, “advertisement offer” refers to a description and/or depiction of one or more goods and/or services included in a display advertisement intended to invite a user to indicate interest in the one or more goods and/or services by selecting the advertisement. In an embodiment, an advertisement offer may not necessarily comprise a legal offer. Rather, in an embodiment, an advertisement offer may comprise a description of a good and/or service, and a user may indicate an interest in the good and/or service by selecting the advertisement offer. In another embodiment, an advertisement offer may include more specific information about a good and/or service, including price, for example, and a user may indicate a more specific intention to purchase the good and/or service by selecting the advertisement offer, for example. Of course, claimed subject matter is not limited in scope in these respects.

In an embodiment, an advertisement offer may be generated at least in part in response to a user engagement with specified content. For example, an advertisement offer may be generated at least in part in response to a user browsing to a specified Web page, in an embodiment. In another embodiment, an advertisement offer may be generated at least in part in response to a user accessing email, for example. In an embodiment, user engagement with content may include, for example, user clicks, views, dwell times, and/or sharing activity (e.g., Facebook “likes”, Twitter “tweets”, etc.), although claimed subject matter is not limited in scope in this respect. Additionally, in an embodiment, an advertisement offer may be generated based, at least in part, on one or more user attributes stored in a user database at a content publisher computing device, for example. In another embodiment, an advertisement offer may be generated based, at least in part, on a user's email content. Further, in an embodiment, generation of an advertisement offer may comprise selecting an advertising campaign from a plurality of advertising campaigns. For example, a content publisher may have contracts with a number of providers, and/or one or more advertising campaigns may be established in partnership with one or more providers, in an embodiment. An advertising campaign may be selected at least in part in response to a specified user browsing to a specified Web page, for example, and a selection of a particular advertising campaign may be based, at least in part, on one or more user attributes and/or on user browsing history, in an embodiment.

Further, as described more fully below, obtaining one or more bids from one or more providers, such as depicted at block 330, for example, may include submitting a selected advertisement offer to an advertisement marketplace and/or exchange, in an embodiment. In an embodiment, an advertisement marketplace and/or exchange may enable matching of advertisement offers with one or more providers, for example.

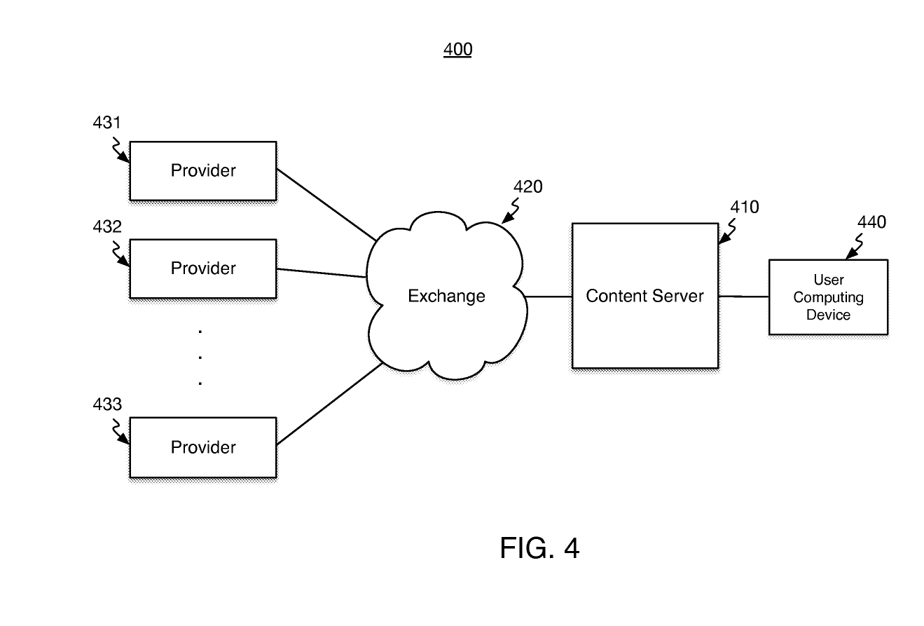

FIG. 4 is a schematic diagram illustrating an embodiment 400 of an example advertisement exchange system. In an embodiment, a content server 410 may host one or more Web sites, including one or more Web pages that may be accessed by a user computing device 440. In another embodiment, a content server 410 may host one or more email services, including one or more email services that may be accessed by user computing device 440. At least in part in response to a user navigating to and/or otherwise engaging with a Web page and/or email service, content server 410 may generate and/or select an advertisement offer to display to the user. In an embodiment, an advertisement offer may be displayed in a region of a Web page and/or along with email content, for example. In an embodiment, an advertisement offer to be displayed to a user may be generated and/or selected by content server 410. In an embodiment, content server 410 may select and/or generate an advertisement offer to display to a user based, at least in part, on one or more user attributes, email content, and/or on user browsing history, for example.

At least in part in response to viewing an advertisement offer, a user may indicate interest in the advertisement offer by clicking and/or otherwise selecting the advertisement offer. For example, a user may hover a mouse icon over an advertisement offer displayed in a graphical user interface of a user computing device, such as user computing device 440, and may press a mouse button to select the advertisement offer, in an embodiment. Of course, claimed subject matter is not limited in scope to any particular technique for receiving user input.

Also, in an embodiment, a user selection of an advertisement offer may result in an opportunity for one or more providers, such as one or more of providers 431, 432, and/or 433, to fulfill a selected advertisement offer. For example, at least in part in response to a user selecting an advertisement offer, a provider, such as provider 431, may provide the advertised good and/or service to the user in exchange for payment from the user.

As used herein, “impression” as it relates to advertising refers to an access of a Web page, email content, advertisement offer, and/or other content over a network, such as the Internet, by a user by a user computing device. A “qualified impression” refers to an opportunity for a provider to fulfill an advertisement offer selected by a user. In an embodiment, a qualified impression may comprise content representative of one or more attributes of a selected advertisement offer and/or one or more user attributes. Further, in an embodiment, a qualified impression may be stored at a content server, for example, as one or more signal states representative of the qualified impression. Additionally, a qualified impression may be transmitted from a first computing device to a second computing device as one or more signals representative of the qualified impression, in an embodiment.

In an embodiment, at least in part in response to a user selecting an advertisement offer, a content server, such as content server 410, may transmit one or more signals representative of a qualified impression indicating a user selection of an advertisement offer to an exchange system, such as exchange 420. At least in part in response to receiving a qualified impression from a content server, such as content server 410, an exchange system, such as exchange 420, may transmit a bid request to one or more providers, such as providers 431-433, for example. In an embodiment, a bid request may include an invitation to bid on a qualified impression.

At least in part in response to receiving a bid request, zero or more of providers 531-433 may respond to exchange 420 with a bid on the qualified impression, in an embodiment. In an embodiment, a bid may comprise an indication of an ability and/or willingness on the part of a provider to fulfill a selected advertisement offer, and/or may include an amount of monetary compensation the provider agrees to pay a content provider for rights to a qualified impression. In an embodiment, one or more providers may bid against one another, and/or a content publisher may select a winning bid based, at least in part, on one or more factors including, for example, an amount of monetary compensation to be paid to a content publisher by a provider. However, claimed subject matter is not limited in scope in these respects.

In an embodiment, it may be possible that no providers submit a bid on a qualified impression in response to a request for bids received from an exchange system, such as exchange 420. For example, a qualified impression may indicate that a user has selected an advertisement offer for a stay at a hotel in a specified city over a specified range of dates. Exchange 420 may transmit a bid request to providers 431-433, and, at least in part in response to the bid request, one or more of providers 431-433 may determine whether sufficient inventory (i.e., vacancy in a hotel in the specified city over the specified range of dates) exists for the provider to fulfill the specified advertisement offer. In some situations, it may occur that no providers are able to bid on a qualified impression, for example due to lack of inventory. In such a situation, a content provider, such as content server 410, may perform a default operation, in an embodiment.

For the specific example described above, in event that no providers provide a bid on a qualified impression for a hotel stay in a specified city over a specified range of dates, content server 410 may direct a browser application executed on user computing device 440 to a Web search page and/or a Web page operated by a travel agent/broker that may allow a user to perform his/her own search for hotel accommodations, in an embodiment. In this manner, even if no providers are available to fulfill a selected advertisement offer, a user may still have a quality browsing/viewing experience. Of course, claimed subject matter is not limited in scope to the specific examples described herein.

In an embodiment, a bidding process may occur approximately in real-time. As utilized herein, “real-time” as it relates to a bidding process of an embodiment of an advertisement system refers to one or more events and/or operations occurring in a short enough amount of time that a user generally experiences little to no perceivable delay between a selection of an advertisement offer and a response by a content provider, such as content server 410. For example, in an embodiment, less than one second of time may elapse between a user selecting an advertisement offer and a user computing device, such as user computing device 440, being directed to display content from a provider, such as provider 431, to enable a user to procure the advertised good and/or service. Of course, claimed subject matter is not limited in scope in these respects.

Further, in an embodiment, an exchange system, such as exchange 420, may perform a bid selection process in an automated fashion, such as without human intervention. An exchange system, such as exchange 420, may comprise one or more computing devices configured and/or programmed to receive input from one or more content publishers, such as content server 410, and/or from one or more providers, such as providers 431-433, in an embodiment. For example, an exchange system, such as exchange 420, may receive content indicative of available inventory for one or more goods and/or services from one or more providers, such as providers 431-433, as part of a bidding operation. Also, in an embodiment, content indicative of other attributes related to one or more goods and/or services may be provided to an exchange system, such as exchange 420, from one or more providers, such as providers 431-433. For example, prices for one or more goods and/or services may be provided to exchange 420.

In an embodiment, bidding operations may occur prior to a user selection of an advertisement offer, concurrent with a user selection of an advertisement offer, and/or in response to a user selection of an advertisement offer. For example, a provider may occasionally and/or periodically submit updated inventory and/or price content to an exchange system, such as exchange 420. In this manner, an exchange system, such as exchange 420, may expeditiously match a qualified impression with one or more bids from one or more providers at least in part in response to a user selection of an advertisement offer.

Returning to the example of a user planning travel to a specified city over a specified range of dates, an exchange system, such as exchange 420, may store room vacancy/availability and/or price content provided by one or more providers, such as providers 431-433, as part of a bidding operation. At least in part in response to receiving a qualified impression indicating a hotel stay in a specified city over a specified range of dates, for example, exchange 420 may access stored room vacancy/availability content provided by one or more providers, such as providers 431-433, and may determine whether one or more providers, such as providers 431-433, have sufficient inventory to fulfill the qualified impression. At least in part in response to a determination that a provider, such as provider 431, has sufficient inventory, an exchange system, such as exchange 420, may indicate to a provider acceptance of a bid submitted by the provider, such as provider 431, in an embodiment. Further, in an embodiment, at least in part in response to obtaining an acceptance of a bid, a provider, such as provider 431, may fulfill a qualified impression at least in part by communicating with a user computing device, such as user computing device 440. For example, user computing device 440 may be directed to navigate to a Web page published by a provider, such as provider 431. Again, claimed subject matter is not limited in scope in these respects.

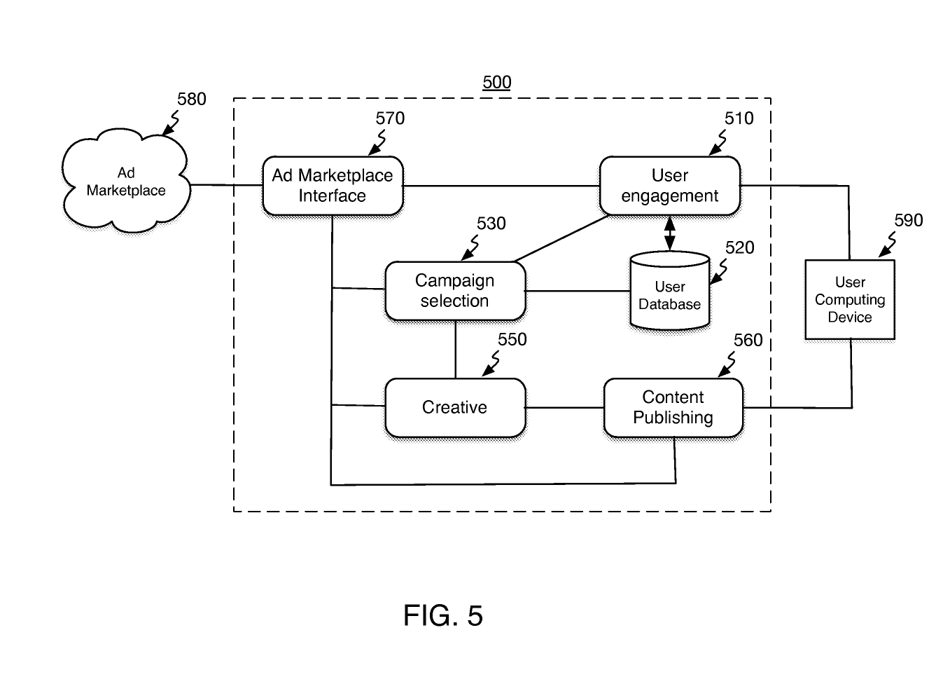

FIG. 5 is a schematic diagram illustrating an embodiment 500 of an example content publisher computing system. In an embodiment, system 500 may comprise an individual computing device. In another embodiment, system 500 may comprise a computing network comprising one or more computing devices. In an embodiment, content publisher computing system 500 may comprise a content publishing module, such as module 560, that may publish content, such as one or more Web pages, email content, and/or one or more advertisements, to a user computing device, such as user computing device 590. Also, in an embodiment, system 500 may comprise a user engagement module, such as module 510, that may monitor and/or track user engagement activity with published content, for example. In an embodiment, user engagement module 510 may monitor and/or track Web pages visited by a user and/or may monitor and/or track an amount of time spent by a user viewing and/or otherwise engaging with a Web page, another example. Further, in an embodiment, user engagement module 510 may monitor and/or track user engagement with email content. Additionally, although example embodiments described herein refer to user engagement with Web pages and/or email content, for example, other embodiments may comprise user engagement with other forms of content. For example, user engagement with text message content, chat content, and/or other types of content may also be tracked and/or monitored in one or more embodiments. Also, claimed subject matter is not limited in scope to the specific examples of user engagement with content described herein.

Also, in an embodiment, example content publisher computing system 500 may comprise a user database, such as database 520, to store user attribute and/or user engagement content, such as may be provided by a user engagement module, such as user engagement module 510. Example system 500 may further comprise an advertisement marketplace interface module, such as module 570, to facilitate communication with an advertisement marketplace, such as advertisement marketplace 580, in an embodiment. As used herein, the terms “marketplace” and “exchange” may be used interchangeably. In an embodiment, advertisement marketplace 580 may comprise an exchange system, such as exchange 420, as described above, for example.

Example content publisher computing system 500 may further comprise an advertisement campaign selection module, such as module 530, in an embodiment. In an embodiment, campaign selection module 530 may store content related to one or more advertising campaigns for one or more providers of goods and/or services. For example, a content publisher may contract with one or more providers to display advertisements and/or advertisement offers to one or more users. In an embodiment, campaign selection module 530 may obtain content related to goods and/or services from one or more providers, such as from one or more providers that may participate in advertisement marketplace 580, for example. Content related to goods and/or services may comprise descriptions of goods and/or services and/or may comprise pricing information for goods and/or services, in an embodiment.

In an embodiment, at least in part in response to user engagement module 510 detecting engagement with content, such as a Web page published by content publisher computing system 500, by a specified user, campaign selection module 530 may select an advertising campaign that may be of interest to the specified user. In an embodiment, campaign selection module 530 may access user browsing history, email content, and/or one or more user attributes stored in user database 520, and may select an advertising campaign based, at least in part, on user browsing history, email content, and/or user attributes. For example, user browsing history, user email content, and/or user attribute content may indicate that the specified user is planning travel to a specified city over a range of specified dates. User browsing history, user email content, and/or user attribute content may also indicate that the specified user has a history of frequenting a particular hotel when the user travels to the specified city. Based at least in part on such indications, campaign selection module 530 may select an advertising campaign related to the specified hotel, although claimed subject matter is not limited in scope in scope in these respects.

In an embodiment, a creative module, such as module 550, may select and/or generate an advertisement offer to display to a specified user. Further, in an embodiment, campaign selection module 530 may communicate with a creative module, such as module 550, to indicate a selected advertising campaign and/or to provide creative module 550 with content sufficient to select and/or generate an advertisement offer to display to a specified user. In an embodiment, creative module 550 may generate an advertisement offer without human intervention. In an embodiment, one or more templates designed at least in part by one or more human users may be utilized, at least in part, to generate one or more advertisement offers by creative module 550, for example, although claimed subject matter is not limited in scope in this respect. Further, creative module 550 may select a previously generated advertisement offer from an advertisement database, in an embodiment.

At least in part in response to selecting and/or generating an advertisement offer, content publishing module 560 may transmit to user computing device 590 one or more signals representative of an advertisement offer to be displayed to a specified user, in an embodiment. In this manner, an advertisement offer, specifically intended to appeal to a specified user's interests, may be displayed to a specified user at least in part in response to the specified user engaging with published content, such as by navigating to a Web page, for example.

In an embodiment, a user may select an advertisement offer displayed at user computing device 590, for example. At least in part in response to a user selection of an advertisement offer, user engagement module 510 may detect the selection, and may indicate the selection to advertisement marketplace interface 570. In an embodiment, advertisement marketplace interface 570 may transmit a request for bids to advertisement marketplace 580, for example. In an embodiment, a request for bids may include a qualified impression representative of a user selection of a specified advertisement offer, for example. Also, in an embodiment, at least in part in response to receiving a request for bids, advertisement marketplace 580 may perform a bidding operations wherein a qualified impression may be matched with one or more bids provided by one or more providers. Advertisement marketplace 580 may accept a bid from one or more bids, and may indicate an accepted bid to advertisement marketplace interface 570, and an indication of an accepted bid may be provided to creative module 550 and/or content publishing module 560, in an embodiment. Also, in an embodiment, a provider may provide an advertisement to be displayed to a specified user at least in part in response to winning a bid to fulfill a qualified impression. For example, a provider may indicate to creative module 550 and/or content publishing module 560 to display an identified advertisement to a specified user at user computing platform 590, in an embodiment. Also, in an embodiment, at least in part in response to an acceptance of a bid, user computing device 590 may be directed to a Web page published by a provider to enable the specified user to procure an advertised good and/or service, for example.

In an embodiment, content publisher computing system 500 may be implemented in hardware, firmware, and/or software, or any combination thereof. Additionally, although content publisher computing system 500 is described herein as comprising a particular configuration of modules, claimed subject matter is not limited in scope in these respects.

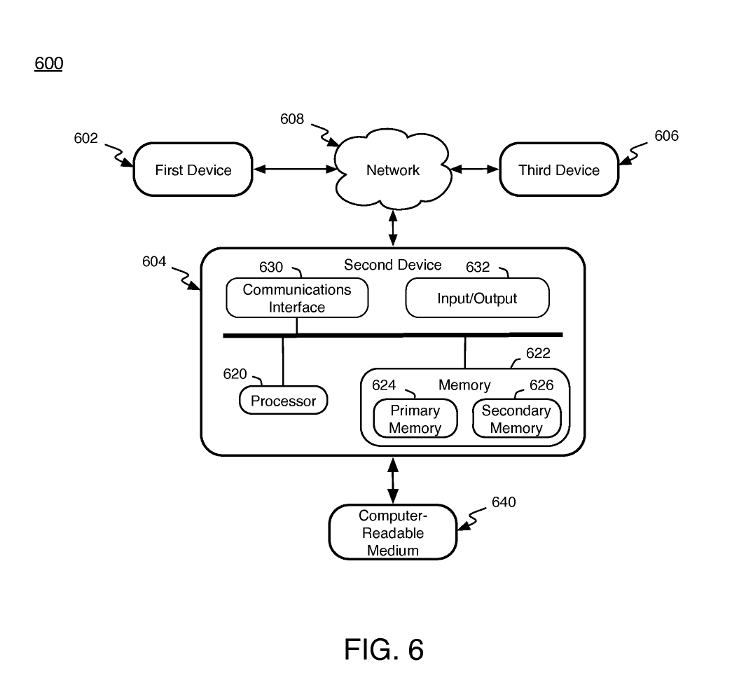

For purposes of illustration, FIG. 6 is an illustration of an embodiment of a system 600 that may be employed in a client-server and/or server-server type interactions, such as described infra. in connection with display advertising, for example. In FIG. 6, computing device 602 (‘first device’ in figure) may interface with computing device 604 (‘second device’ in figure), which may comprise features of a server computing device, for example. Communications interface 630, processor (e.g., processing unit) 620, and memory 622, which may comprise primary memory 624 and secondary memory 626, may communicate by way of a communication bus, for example. In FIG. 6, computing device 602 may represent one or more sources of analog, uncompressed digital, lossless compressed digital, and/or lossy compressed digital formats for content of various types, such as video, imaging, text, audio, etc. in the form physical states and/or signals, for example. Computing device 602 may communicate with computing device 604 by way of a connection, such as an internet connection, via network 608, for example. Although computing device 604 of FIG. 1 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Processor 620 may be representative of one or more circuits, such as digital circuits, to perform at least a portion of a computing procedure and/or process. By way of example, but not limitation, processor 620 may comprise one or more processors, such as controllers, microprocessors, microcontrollers, application specific integrated circuits, digital signal processors, programmable logic devices, field programmable gate arrays, the like, or any combination thereof. In implementations, processor 620 may perform signal processing to manipulate signals and/or states, to construct signals and/or states, etc., for example.

Memory 622 may be representative of any storage mechanism. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 622 may be utilized to store a program. Memory 622 may also comprise a memory controller for accessing computer readable-medium 640 that may carry and/or make accessible content, which may include code, and/or instructions, for example, executable by processor 620 and/or some other unit, such as a controller and/or processor, capable of executing instructions, for example.

Under direction of processor 620, memory, such as memory cells storing physical states, representing, for example, a program, may be executed by processor 620 and generated signals may be transmitted via the Internet, for example. Processor 620 may also receive digitally-encoded signals from client computing device 602.

Network 608 may comprise one or more network communication links, processes, services, applications and/or resources to support exchanging communication signals between a client computing device, such as 602, and computing device 606 (‘third device’ in figure), which may, for example, comprise one or more servers (not shown). By way of example, but not limitation, network 608 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 604, as depicted in FIG. 6, is merely one example, and claimed subject matter is not limited in scope to this particular example. For one or more embodiments, a computing device may comprise any of a wide range of digital electronic devices, including, but not limited to, personal desktop and/or notebook computers, server computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing device.

Memory 622 may store cookies relating to one or more users and may also comprise a computer-readable medium that may carry and/or make accessible content, including code and/or instructions, for example, executable by processor 620 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra wideband (UWB), 802.11b/g/n, and/or the like. A wireless network may include virtually any type of now known and/or to be developed wireless communication mechanism by which signals may be communicated between devices, between networks, within a network, and/or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a Web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets and/or frames, such as in a network of participating digital communications. A broadcast domain may be compliant and/or compatible with, but is not limited to, now known and/or to be developed versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A broadcast domain may employ, for example, TCP/IP, UDP, DECnet, NetBEUI, IPX, Appletalk, other, and/or the like. Versions of the Internet Protocol (IP) may include IPv4, IPv6, other, and/or the like.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method, comprising:
transmitting one or more signals indicative of specified content and an advertisement offer to a user computing device utilizing, at least in part, a communications interface of a content publisher computing device, the specified content and the advertisement offer to be displayed to a user;
detecting, utilizing at least in part a processor of the content publisher computing device, a selection by a user of the advertisement offer; and
at least in part in response to the user selection of the advertisement offer, obtaining one or more bids from one or more providers to fulfill the selected advertisement offer.

2. The method of claim 1, further comprising:
detecting a user engagement with the specified content; and
generating the advertisement offer to be displayed with the specified content to the user.

3. The method of claim 2, wherein the user engagement with the content comprises the user browsing to a Web page and/or accessing email.

4. The method of claim 2, wherein said generating the advertisement offer comprises generating the advertisement offer utilizing, at least in part, the processor of the content publisher computing device based, at least in part, on one or more user attributes stored in a user database at the content publisher computing device.

5. The method of claim 4, wherein said generating the advertisement offer further comprises selecting an advertising campaign from a plurality of advertising campaigns based, at least in part, on the one or more user attributes.

6. The method of claim 1, wherein said obtaining the one or more bids from the one or more providers comprises submitting the selected advertisement offer to an advertisement marketplace.

7. The method of claim 6, further comprising selecting a provider from the one or more providers based, at least in part, on the one or more bids.

8. An apparatus, comprising: a processor of a computing device to:
initiate transmission of one or more signals indicative of specified content and an advertisement offer to a user computing device, the specified content and the advertisement offer to be displayed to a user;
detect a selection by a user of the advertisement offer; and
at least in part in response to the user selection of the advertisement offer, obtain one or more bids from one or more providers to fulfill the selected advertisement offer.

9. The apparatus of claim 8, the processor further to:
detect a user engagement with the specified content; and
generate the advertisement offer to be displayed with the specified content to the user.

10. The apparatus of claim 9, wherein the user engagement with the content comprises the user browsing to a Web page and/or accessing email.

11. The apparatus of claim 9, the apparatus comprising a content publisher computing device, the processor further to generate the advertisement offer based, at least in part, on one or more user attributes stored in a user database at the content publisher computing device.

12. The apparatus of claim 11, the processor further to select an advertising campaign from a plurality of advertising campaigns based, at least in part, on the one or more user attributes at least in part to generate the advertisement offer.

13. The apparatus of claim 8, the processor further to submit the selected advertisement offer to an advertisement marketplace at least in part to obtain the one or more bids from the one or more providers.

14. The apparatus of claim 13, the processor further to select a provider from the one or more providers based, at least in part, on the one or more bids.

15. An apparatus, comprising:
means for transmitting one or more signals indicative of specified content and an advertisement offer to a user computing device, the specified content and the advertisement offer to be displayed to a user;
means for detecting a selection by a user of the advertisement offer; and
means for obtaining one or more bids from one or more providers to fulfill the selected advertisement offer at least in part in response to the user selection of the advertisement offer.

16. The apparatus of claim 15, further comprising:
means for detecting a user engagement with the specified content; and
means for generating the advertisement offer to be displayed with the specified content to the user.

17. The apparatus of claim 16, wherein the user engagement with the content comprises the user browsing to a Web page and/or accessing email.

18. The apparatus of claim 16, wherein said means for generating the advertisement offer comprises means for generating the advertisement offer based, at least in part, on one or more user attributes stored in a user database.

19. The apparatus of claim 18, wherein said means for generating the advertisement offer further comprises means for selecting an advertising campaign from a plurality of advertising campaigns based, at least in part, on the one or more user attributes.

20. The apparatus of claim 15, wherein said means for obtaining the one or more bids from the one or more providers comprises means for submitting the selected advertisement offer to an advertisement marketplace.

21. The apparatus of claim 15, further comprising means for selecting a provider from the one or more providers based, at least in part, on the one or more bids.

22. An article, comprising: a storage medium having stored thereon instructions executable by a computing device to:
initiate transmission of one or more signals indicative of specified content and an advertisement offer to a user computing device, the specified content and the advertisement offer to be displayed to a user;
detect a selection by a user of the advertisement offer; and
at least in part in response to the user selection of the advertisement offer, obtain one or more bids from one or more providers to fulfill the selected advertisement offer.

23. The article of claim 22, wherein the storage medium has stored thereon further instructions executable by the processor to:
detect a user engagement with the specified content; and
generate the advertisement offer to be displayed with the specified content to the user.

24. The article of claim 23, wherein the user engagement with the content comprises the user browsing to a Web page.

25. The article of claim 23, the computing device comprising a content publisher computing device, wherein the storage medium has stored thereon further instructions executable by the processor to generate the advertisement offer based, at least in part, on one or more user attributes stored in a user database at the content publisher computing device.

26. The article of claim 25, wherein the storage medium has stored thereon further instructions executable by the processor to select an advertising campaign from a plurality of advertising campaigns based, at least in part, on the one or more user attributes at least in part to generate the advertisement offer.

27. The article of claim 22, wherein the storage medium has stored thereon further instructions executable by the processor to submit the selected advertisement offer to an advertisement marketplace at least in part to obtain the one or more bids from the one or more providers.

28. The article of claim 27, wherein the storage medium has stored thereon further instructions executable by the processor to select a provider from the one or more providers based, at least in part, on the one or more bids.
